(19) United States
(12) Patent Application Publication
(10) Pub. No.: US 2026/0054939 A1
(43) Pub. Date: Feb. 26, 2026

(54) METHOD FOR OPERATING A CONTAINER TREATMENT PLANT, AND CONTROL APPARATUS FOR A CONTAINER TREATMENT APPARATUS

(71) Applicant: KRONES AG, Neutraubling (DE)

(72) Inventor: Alexander HEWICKER, Wörth an der Donau (DE)

(21) Appl. No.: 19/307,949

(22) Filed: Aug. 22, 2025

(30) Foreign Application Priority Data
Aug. 22, 2024 (DE) 10 2024 124 078.4

(51) Int. Cl. B65G 43/08; B65G 49/00

(52) U.S. Cl. CPC B65G 43/08; B65G 49/00; B65G 2201/0235; B65G 2203/042

(57) ABSTRACT

To carry out a container inspection task, a sensor device optically detects sensor data and camera images relating to the container parts, and a real-time evaluation device evaluates spatially resolved sensor data in real time using a machine learning container inspection model which includes a set of parameters which are set to values which were learned as a result of a machine learning method. A set of container part features based on a machine learning method is predetermined, and the detected, spatially resolved sensor data are evaluated in relation to a plant inspection task different from the container inspection task, based on the predetermined set of container part characteristics, a plant inspection variable being determined depending on the inspection result of the carried out plant inspection task, which is provided for the control and/or regulation of the container treatment plant.

### CROSS REFERENCE OF RELATED APPLICATIONS

The present application claims benefit to German Patent Application Serial no. 10 2024 124 078.4, filed Aug. 22, 2024, the contents of which are incorporated herein by reference.

### BACKGROUND OF THE INVENTION

The present invention relates to a method for operating a container treatment plant for treating a plurality of container parts for containers and preferably for plastics containers and/or bottles, as well as a control apparatus for a container treatment plant, and a container treatment plant. In this case, a transport device is provided which transports the plurality of container parts as a container part stream along a predetermined transport path.

The containers are preferably plastics containers (in particular PET containers), containers whose main component consists of pulp and/or glass containers and/or cans. In this case, the containers may be containers from the beverage and/or food and/or cosmetics and/or pharmaceuticals industries.

From DE 10 2021 133 164 B3 a method for carrying out a setting operation of a container inspection apparatus is known. A sensor device therein records spatially resolved sensor data relating to the containers to be inspected, and a real-time evaluation device evaluates the spatially resolved sensor data of the individual inspected containers in real time using an adjustable real-time container inspection model. Furthermore, a plurality of spatially resolved sensor data are provided on a non-volatile memory device. In a setting operation, a setting device retrieves the stored plurality of spatially resolved sensor data and evaluates a test container inspection model based on the retrieved plurality of spatially resolved sensor data.

In this case, the test container inspection model is evaluated on the basis of a rejection rate based on the retrieved plurality of spatially resolved sensor data.

An assessment based on whether or not a container associated with detected sensor data should be removed from the container part stream depends essentially on a predetermined threshold value which indicates from when a container with a defect characteristic should be removed or not. Containers which are not completely free of defects, but whose defect characteristic is not sufficiently pronounced for the container to be assessed as to be discarded, are classified as “defect-free” in such an evaluation.

In this case, as the applicant has recognized in the context of the invention, valuable information remains unconsidered which may result from containers that are not completely free of defects and are not discharged.

The present invention is based on the object of overcoming the disadvantages known from the prior art and of providing a method for operating a container treatment plant for treating a plurality of container parts for containers, a container treatment plant, as well as a control apparatus for a container treatment plant which offer improved, finely adjustable operation with high-quality treatment of the container parts.

### SUMMARY OF THE INVENTION

In a method according to the invention for operating a container treatment plant for treating a plurality of container parts for containers and preferably for plastics containers and/or bottles, a transport device transports the plurality of container parts as a container part stream along a predetermined transport path, preferably from and/or to at least one treatment device of the container treatment plant and particularly preferably from at least one treatment device of the container treatment plant to at least one further treatment device of the container treatment plant (for carrying out at least one treatment step on the plurality of container parts).

The containers are preferably plastic containers (in particular PET containers), containers whose main component consists of pulp and/or glass containers and/or cans. In this case, the containers may be containers from the beverage and/or food and/or cosmetics and/or pharmaceuticals industries. For example, they can be cans or bottles, such as glass bottles, pulp bottles and plastic bottles.

A “container part for a container” can also be understood to mean the container itself. For example, the container part could be a preform from which the finally shaped container is produced through a forming process, or it could be the already finally shaped container.

The container part for a container can also be an equipment of the container, such as a (preferably resealable) container closure (e.g. screw cap or cap), a (PET and/or plastics) lid, a label, a (laser or direct print) marking, a filling material and/or packaging of the (finished) container, a container assembly, or the like (as well as combinations thereof).

For example, the transport device can be a supply (e.g. a supply rail) for container closures, which supplies the container closures from a collecting device to a closing device for closing containers.

Preferably, the container part is an object that can be transported and is transported (independently of other transported container parts) by the transport device as (exactly one) unit.

Preferably, the at least one (first) treatment device and/or the (at least one) further treatment device (in particular each) carries out at least one treatment step on the container part (and preferably on the container) and/or on the plurality of container parts.

In this case, the at least one treatment step is carried out in particular on each container part of the plurality of container parts.

The treatment step of the at least one (first) treatment device and/or the (at least one) further treatment device can be selected from a group of treatment steps which includes an injection molding process for producing an injection-molded part (for example a plastics material preform), a cleaning process, a comminution process and/or division process (for example as part of a recycling process), a forming process (in particular (stretch) blow molding), a (laser) marking process, an individualization process (for example applying a QR code), a diversion process (in which the container part is diverted from the container part stream of the container treatment plant), a sorting process (in which the container parts are sorted according to type), a filling process, a closing process, a (in particular direct) printing process, a labeling process, undertaking laser decoration, a process for strapping (a container part and preferably a container), a packaging process (in particular applying a primary and/or secondary packaging such as welding several containers as a package and/or as a packaging unit), in particular carrying out shrink packaging, determining the composition of substances or mixtures of substances such as the atmosphere and/or air in or on a container part and preferably a container, for example using a mass spectrometer and/or an odor sensor device, and the like, as well as combinations thereof.

In order to carry out (at least) one container inspection task, at least one sensor device detects, in particular spatially resolved, sensor data and preferably camera images with respect to the container parts (to be inspected and/or transported), preferably optically (preferably during working mode of the container treatment plant). The sensor device is preferably a sensor device of the container treatment plant and/or a container inspection device described in more detail below.

Preferably, the transport device transports the plurality of container parts (to be treated and/or treated) (for inspection thereof in order to fulfill the container inspection task) to the sensor device which in each case detects, in particular spatially resolved, sensor data with respect to the transported container parts (in particular individually). The sensor device and/or the container inspection device comprising the at least one sensor device (described in more detail below) can be arranged between the treatment device and the at least one further treatment device.

Preferably, the container part (to be inspected) is imaged in the sensor data at least in part and preferably its container part region that is observable or visible from at least one observation direction.

It is conceivable that sensor data are detected or collected individually or per container part for each container part to be inspected and/or transported to the sensor device (in each case in a separate detection step of the sensor device).

Exactly one sensor device can be provided which detects the sensor data required to carry out the container inspection task with regard to the container parts. However, it is also conceivable that several sensor devices are provided for this purpose, which, for example, detect the sensor data from several recording directions in relation to the container part and/or which, in a multi-lane transport region, record the container parts transported on different lanes.

The sensor data are preferably spatially resolved sensor data which in particular depict a property to be detected (such as color value and/or gray value and/or brightness value) of a region of the container part. Preferably, the spatially resolved sensor data indicate (or can indicate) a sensor data profile depending on at least one spatial and/or geometric coordinate and preferably depending on at least two spatial and/or geometric coordinates.

The sensor data can be, for example, a color value and/or gray value and/or brightness value such as in the case of the sensor data detected by a camera.

The sensor data detected by a LIDAR device can be RGB values and/or intensity values which are detected and stored for each detected data point together with or depending on its X, Y and Z position value.

It is also conceivable that the sensor data are frequency-resolved sensor data.

For example, at least one intensity value can be recorded for each sensor data point depending on a frequency of the radiation detected by the sensor device so that the sensor data indicate a sensor value curve depending on a frequency.

It is also conceivable that the sensor data are spectrometer sensor data which are preferably generated by a mass spectrometer which is used, for example, as an odor sensor. It is conceivable for e.g. the composition of a gas and/or air and/or air mixture, such as an atmosphere in a container to be analyzed therewith. Here, for example, the detected sensor data can indicate an intensity value curve depending on a mass-to-charge ratio of atoms and molecules contained in the atmosphere.

Preferably, the detection of the sensor data, in particular spatially resolved data, is an optical detection. The spatially resolved sensor data are preferably camera images.

Preferably, the sensor data relating to the container parts to be inspected are detected during the transport of these container parts to be detected at an unchanged, in particular non-reduced, transport speed, i.e. while the container parts are in motion. In other words, the container parts are not slowed down and/or stopped to detect the sensor data. This offers the advantage of a high throughput speed and production speed of the container treatment plant.

For optical detection of the sensor data, illumination of the container parts and preferably containers can be provided, such as incident light and/or transmitted light.

A real-time, in particular processor-based, evaluation device evaluates (in order to carry out the (at least one) container inspection task) the in particular spatially resolved sensor data, in particular in real time, using a container inspection model (as part of a computer-implemented method step).

The container inspection model is preferably a machine learning container inspection model that includes a set of parameters that are set to values which were learned as a result of a machine learning method (or a training process).

The real-time evaluation device is preferably part of the container treatment plant and/or the container inspection device (described in more detail below).

According to the invention, a set of container part features based on a, and preferably the, (above) machine learning method is predetermined and/or will be predetermined (preferably to the real-time evaluation device).

Preferably (preferably by the real-time evaluation device), the detected, in particular spatially resolved, sensor data are evaluated with respect to a plant inspection task different from the container inspection task (or for carrying out a plant inspection task different from the container inspection task) based on the predetermined set of container part characteristics. Preferably, depending on the inspection result of the performed plant inspection task, at least one plant inspection variable is determined which is provided for the (at least partially automatic and preferably fully automatic) control and/or regulation of the container treatment plant. In this case, it may be that, in order to carry out the plant inspection task, in particular detected sensor data are selected which have achieved a predetermined inspection result in the carried out container inspection task (e.g. that no predetermined defect was identified or that the sensor data were generally classified as defect-free).

Additionally or alternatively, the detected, in particular spatially resolved, sensor data (in particular with respect to a plant inspection task different from the container inspection task or for carrying out a plant inspection task different from the container inspection task) are preferably evaluated with respect to predetermined and/or predeterminable reference data by determining a similarity variable which is characteristic of a similarity of the sensor data to the reference data. In this case, the similarity variable or a variable derived therefrom is provided for the control and/or regulation of the container treatment plant. In this case, the similarity variable is preferably determined based on a predetermined set of container part features, particularly preferably based on the machine learning method (described above). In this case, the similarity variable can serve as a plant inspection variable. It is also conceivable that the plant inspection variable is determined depending on the similarity variable and preferably depending on a plurality of similarity variables.

Preferably, the container treatment plant is controlled and/or regulated (at least partially automatically and preferably fully automatically) depending on the at least one (determined) plant inspection variable and/or depending on the inspection result of the carried out plant inspection task (and/or depending on the similarity variable). In this case, an execution of at least one treatment step carried out by the container treatment plant and particularly preferably of the at least one treatment step (to be carried out on the plurality of container parts) and/or an operating state of the container treatment plant (depending on the at least one plant inspection variable and/or depending on the inspection result of the carried out plant inspection task and/or depending on the similarity variable) is controlled and/or regulated.

In other words, a first preferred embodiment of the method proposes that not only a container inspection model for evaluating the sensor data is generated in a machine learning process, in which model, for example, the sensor data can be categorized according to defects and/or types of container parts detected therein, but that, in addition, means are provided in the form of the set of container part features obtained as part of one and preferably the same machine learning method, by which the sensor data can also be evaluated with regard to a mode of functioning and control/regulation of the container treatment plant.

In other words, a second preferred embodiment of the method proposes evaluating the sensor data not only using a machine learning container inspection model for carrying out a container inspection task (for example for categorizing defects on the container parts and/or identified container part types identified in the sensor data), but also using a similarity analysis to predetermined reference data.

The reference data are preferably sensor data (relating to a container part), preferably detected by a sensor device, in particular spatially resolved, which are used as a reference, i.e. as reference sensor data (hereinafter also referred to as reference sensor data). In this case, the sensor device can be the sensor device which detects the, in particular spatially resolved, sensor data (with respect to which the deposit variable is to be determined or is determined).

Additionally or alternatively, it may be a sensor device that is different (approximately identical in construction) from the sensor device (of the container treatment plant) that detects the, in particular spatially resolved, sensor data. For example, the sensor device that detects the reference sensor data could be a further sensor device in the same container treatment plant.

In addition, sensor data detected by an identically constructed sensor device in a different container treatment plant could also be used as reference sensor data. This offers the advantage that it is possible to check, for example, whether very rarely occurring defects discovered in the various container treatment plants or features in the treated container part resulting from a malfunction in the container treatment plant also occur in the container treatment plant under consideration.

In this case, the reference data are preferably stored in a memory device of the container treatment plant and particularly preferably of the container inspection apparatus which comprises the sensor device.

In particular, the detected, in particular spatially resolved, sensor data are compared with the reference data, and the similarity variable is determined from the comparison result.

In this case, the first preferred embodiment and the second preferred embodiment of the method can be present independently in a method. The first and second preferred embodiments of the method can also both be implemented in a common method. The features listed below can therefore relate both to the first preferred embodiment described above and to the second preferred embodiment, or to an implementation of both preferred embodiments of the method.

Preferably, the similarity variable is a non-discrete variable which, in particular, cannot assume only two or a finite (fixed) number of values. Preferably, the similarity variable is a continuous variable. Preferably, the similarity variable indicates a degree of similarity.

While the container inspection model preferably assigns at least one category from a plurality of predefined categories to the detected sensor data, the sensor data can thereby preferably be evaluated even more finely by determining a non-discrete similarity variable. This means for example that slowly progressing development trends, which may arise for example in the case of aging of components of the container treatment plants or a change in the production materials and which affect the treatment of the container parts, can already be discovered at a very early stage in which the categorization of the container parts is not yet influenced by the changed treatment of the container part.

In a preferred method, the set of container part features is a set of container part features obtained, preferably automatically, in the context of a and preferably the machine learning method, in particular extracted by a neural network. Preferably, the set of container part features results from the machine learning method (automatically).

The machine learning method is preferably the machine learning method that was carried out to obtain the container inspection model. However, it is also conceivable that the set of container part features from a machine learning method relates to a training container inspection task (to be carried out by the real-time evaluation device on the basis of the detected, in particular spatially resolved, sensor data) different from the container inspection task.

In this case, the training container inspection task is preferably different from a container inspection task. The container part features are preferably extracted by a machine learning method or by performing a machine learning method that is carried out with respect to a training container inspection task. The machine learning method is carried out to obtain a (trained) algorithm or a (trained) model (of machine learning) which serves to fulfill or carry out the training container inspection task.

Preferably, the set of extracted container part features is a set of (extracted) container part features (automatically) extracted as part of the machine learning method carried out with respect to the training container inspection task.

The fact that a training container inspection task different from the container inspection task can be used offers the advantage that only a single training process or a single machine learning method, namely the training process or machine learning method carried out as part of the training container inspection task, is sufficient for feature extraction. The extracted container part features obtained here are then used for other container inspection tasks.

For example, the extracted feature vectors of a bottle in a (camera) image can be used in several inspection tasks/classifications.

Example of two inspection tasks/classifications:
1. Do the feature vectors show a brown bottle?
2. Do the feature vectors show a closed bottle?

Both can be seen in an image and thus also in the extracted feature vector.

In the first case, the machine learning algorithm, such as kNN, is then “trained” with feature vectors of brown and other colored bottles; in the second case, with feature vectors of closed and open bottles.

The features only need to be extracted once from each image.

In a further preferred method, the learning method in which the set of container part features is extracted is a supervised learning method. Preferably, a set of training data is used to carry out the supervised learning method, which comprises (detected) sensor data relating to container parts which are labeled or marked with an inspection result, to be obtained in the respective case, of the predetermined (training) container inspection task (for example a predetermined plurality of categories).

In a further preferred method, the supervised learning method is a K-nearest neighbor algorithm (also abbreviated as “k-NN” or “KNN”). This is advantageously a simple algorithm that can be easily adapted to newly added training patterns. The K-nearest neighbor algorithm only requires a k-value and a distance metric, which is little compared to other machine learning algorithms.

In a further preferred method, a traditional machine learning algorithm is used (as a learning method) such as decision trees (decision tree learning, wherein a decision tree is a non-parametric, supervised learning algorithm with preferably a hierarchical, tree-like structure which is used, for example, for both classification and regression tasks), random forests or random decision forest, logistic regression, k-means clustering, support vector machines (abbreviation SVM, or support vector method).

In particular, in this case, the extracted container part features are not predefined features, nor are they a selection of predefined features (e.g. by a user). The extracted container part features are in particular abstract features which indicate or are characteristic of a light-dark contrast, a variable characteristic of a frequency of straight lines (such as how many straight lines), a brightness or a brightness gradient, shapes of contours (lines) and/or boundary lines, corners, shapes, numbers of corners, curvatures, combinations thereof and the like.

Preferably, the (in particular all) container part features are generated automatically, preferably as part of the machine learning method (and in particular not selected).

Preferably, the set of extracted container part features is not adapted and/or changed, even when a (new and/or additional and/or to be adapted) container inspection task and/or a new/changed plant inspection task is specified, and/or when new/changed reference data or reference sensor data are predetermined.

Preferably, the set of container part features can be accessed, in particular also the individual container part features of the set of container part features. The set of container part features is therefore not implicitly contained in an image evaluation algorithm (as a kind of “black box”), but is stored in such a way that it can be accessed independently and separately. Particularly preferably, the set of container part features can also be exchanged separately (in particular independently of further software modules). It is also conceivable that this set of container part features can only be output and/or transmitted on its own.

It is conceivable that a number of the container part features of the set of extracted or to be extracted container part features is predetermined, for example by a user of the container treatment plant. Preferably, the predetermined number of container part features is taken into account when determining the set of container part features to be extracted. This predetermined number of container part features can be transmitted, for example, by the user of the container treatment plant to an external server which carries out the determination of the set of container part features to be extracted. However, it is also conceivable that the number of container part features is predetermined by a manufacturer of the container treatment plant and, in particular, cannot be influenced by the container treatment plant (or by an operator thereof).

In a further preferred method, a feature space is or will be spanned by the set of extracted container part features, or a feature space spanned by the set of container part features is provided. In other words, a feature space can be formed which is spanned by the provided set of extracted container part features.

Preferably, a distance metric with respect to the feature space is provided.

Preferably, the similarity variable is determined using the distance metric. In this case, the in particular spatially resolved sensor data and/or the reference sensor data are preferably each represented in the feature space (as a feature vector). A distance between these two feature vectors is preferably determined using the distance metric. This distance or a variable characteristic thereof is preferably used as a similarity variable between the detected, in particular spatially resolved, sensor data and the reference sensor data.

The reference data could, for example, already be a representation of (reference) sensor data in the feature space. For example, the reference data could thus already be a feature vector (or be characteristic thereof). Reference data (predefined) already specified as a feature vector offer the advantage of a significantly smaller data size.

In other words, a distance metric is preferably provided with respect to the feature space, wherein additionally or alternatively, (preferably the real-time evaluation device) the distance metric is used as a measure of similarity between, in particular spatially resolved, sensor data of different container parts and preferably different containers and/or as a measure of similarity between detected sensor data and reference sensor data.

Preferably (as part of the implementation of the plant inspection task) a similarity between detected, in particular spatially resolved, sensor data of a container part with those of another container part (e.g. predetermined as reference sensor data) is assessed using the distance metric.

Preferably, a feature vector is created for all detected (in particular spatially resolved) sensor data, i.e. for example for each recorded camera image, based on the set of extracted container part features. The feature vector can, for example, be a 256-dimensional vector.

Preferably, the feature vector has a maximum of 512 dimensions, preferably a maximum of 256 dimensions, and particularly preferably a maximum of 128 dimensions. Preferably, the feature vector has at least 16, preferably at least 32, preferably at least 64 and particularly preferably at least 128 dimensions. In principle, however, feature vectors with more than 512 dimensions or a feature space with correspondingly higher dimensionality could also be used.

Preferably, the distance metric can be used to determine the distance between the feature vector of sensor data detected with respect to a first container part and the feature vector of the sensor data detected with respect to a further container part.

In other words, the distance metric is preferably used as a measure of similarity to assess the similarity between the detected, in particular spatially resolved, sensor data and the reference data, in particular the reference sensor data, to determine the similarity variable.

In a further preferred method, a Euclidean metric and/or a cosine similarity in the feature space is used as the distance metric. The cosine similarity (also known as cosine distance) is a measure of the similarity of two vectors, in which the cosine of the angle between the two vectors is determined. In particular, cosine similarity can be understood as a measure of how strongly two vectors point in the same direction. The cosine similarity between two vectors a and b can be calculated in particular from the standard scalar product of the vectors a and b, divided by the Euclidean norm of a and the Euclidean norm of b, thus: Cosine similarity=(a−b)/(∥a∥ ∥b∥).

A (comparatively) small distance between two feature vectors (in the feature space) obtained with the distance metric is preferably regarded as a low similarity between the two items of sensor data (or sensor data and reference (sensor) data) corresponding to the respective feature vectors. Conversely, a (comparatively) large distance between two feature vectors (in the feature space) obtained with the distance metric is preferably regarded as a high similarity between the two items of sensor data (or sensor data and reference (sensor) data) corresponding to the respective feature vectors.

In a further preferred method, on the basis of the evaluation of the sensor data detected with respect to a container part, based on the set of container part features, a movement of the container part through the container treatment plant is tracked at least partially. This offers the advantage that it is possible to determine whether the container part has already reached/passed the sensor device or several sensor devices of the container treatment plants, and/or whether an inspected container part has already reached the sensor device several times.

In a further preferred method, the tracking of the container part is carried out without a treatment step carried out and/or provided for individualization having been and/or being carried out on the container part. For example, the container part was not given a unique code that individualizes the container part, such as a QR code or the like. The applicant has discovered that container parts can be identified and recognized solely on the basis of the various degrees of container part features (extracted in a machine learning method).

For example, the sensor device (or the real-time evaluation device) can detect contamination of a contaminated container and, in response to this container inspection task (here the detection of contamination), send the container to a cleaning device for cleaning the container. After the cleaning process has been completed, the container can be fed back to the container inspection apparatus and in particular to the sensor device using the transport device. Based on the evaluation of the sensor data now detected with regard to the container after a cleaning process has been completed, it is advantageously possible to recognize not only that the contamination of the container (still) exists, but also that this container (with this contamination) has already been detected once by the sensor device and has therefore already undergone a cleaning process (at least once). This can prevent, for example, contamination that cannot be removed by the cleaning device from causing the same container to go through or have gone through a cleaning and inspection cycle several times and thus blocking capacity for other containers.

Preferably, the number of times a container part has already been detected by the sensor device or has reached it is counted (in particular by the real-time evaluation device and/or the container inspection apparatus). Preferably, a maximum number can be predetermined and/or is predetermined (by an operator) (and is stored and/or can be stored in a memory device of the container inspection apparatus and/or the container treatment plant), and preferably a control and/or regulation of the container treatment plant, and in particular of a rejection device for rejecting container parts inspected by the sensor device, is dependent on the predetermined maximum number in comparison to the number of times the respective container part has already reached the sensor device and/or been detected.

In a further preferred method, based on the set of container part features, the sensor data detected with respect to a container part are evaluated in such a way that at least one identification variable characteristic of the container part is determined.

Preferably, a feature vector is used as the identification variable, by means of which the associated detected sensor data can be represented or are represented in the feature space. This identification variable is preferably stored on a memory device (in particular the container inspection apparatus and/or the real-time evaluation device and/or the container treatment plant). This offers the advantage that storing the sensor data can be dispensed with, which makes it possible to save storage space.

Preferably, this identification variable is compared with (at least) one identification variable determined for further sensor data detected by the sensor device. Preferably, a distance between the two feature vectors used as identification variables is determined. Preferably, on the basis of the determined distance (using the distance metric), it is assessed whether the associated detected sensor data are sensor data of the same container part.

Preferably, a threshold value distance is predetermined and/or can be predetermined for this (by an operator). If the distance (spacing) between two feature vectors (or identification variables) (determined using the distance metric) falls below this threshold distance, the assessment result is assumed to be that the associated detected sensor data are sensor data from the same container part.

In a further preferred method, based on the evaluation of the sensor data detected with respect to a container part, it is checked using the set of container part features whether an individual container part has reached (preferably repeatedly) the sensor device or at least one further sensor device of the container treatment plant. Preferably, a similarity variable is determined for this purpose, which is characteristic of the similarity of the sensor data detected in each case. In this case, the similarity variable can be determined with the distance metric described above (as a measure of the similarity).

In this case, the at least one further sensor device is arranged, for example, downstream with respect to the transport direction of the container parts. In addition to the sensor device, the at least one further sensor device preferably also detects sensor data relating to the (preferably each) container part. Preferably, the sensor devices detect the container part from the same detection direction with respect to the container part. Preferably, by determining the similarity variable (as proposed above) based on the distance metric on the basis of the detected sensor data, it can be assessed whether it is the same container part. In this way, it can be determined whether and/or when the container part reaches the at least one further sensor device. If a plurality of further sensor devices are provided (e.g. along the entire transport path through the container treatment plant), a movement of the (individual) container part through the (entire) container treatment plant can be tracked.

In a further preferred method, in order to check for repeatedly reaching the sensor device detecting the individual container part, an identification variable characteristic of the container part (such as a feature vector) is determined based on the set of container part features, and on the basis of the determined identification variable, a similarity to sensor data subsequently detected by the sensor device is determined. For example, the similarity can be determined by determining the distance between the identification variable selected as the feature vector and a feature vector that is determined for the sensor data subsequently detected by the sensor device.

In a further preferred method, if it is determined that the sensor device is repeatedly reached by a container part, a renewed transport of the container part to this sensor device is prevented, preferably by individually changing at least one previous treatment step with respect to the container part and particularly preferably by discharging the container part from the container part stream. Thus, for example, a cleaning step that this container part has to go through can be modified, and/or the container part can be (finally) discharged from the container part stream.

In a further preferred method (not only in the above-mentioned second preferred embodiment but also in the first preferred embodiment of the proposed method), reference data are predetermined and/or predeterminable, and the control and/or regulation is based on a determined similarity variable which is characteristic of a similarity between the reference data and detected sensor data (with respect to at least one container part and preferably with respect to a plurality of container parts in each case).

In a further preferred method, at least one treatment step and/or at least one operating state of the container treatment plant is changed and/or adapted depending on the inspection result of the plant inspection task. Preferably, the treatment step and/or the at least one operating state is controlled and/or regulated depending on the inspection result of the plant inspection task, and particularly preferably depending on a similarity variable determined on the basis of the detected sensor data and (in particular predetermined) reference (sensor) data.

For example, (detected) sensor data (as reference sensor data) or feature vectors for container parts are predetermined as reference data which are/to be classified (preferably using the container inspection model of machine learning) in such a way that the associated container part is not defect-free and/or must be rejected. For example, the container part depicted in the reference sensor data or the container part associated with the feature vector could have a predetermined defect which is identified as such by the real-time evaluation device when the container inspection task is carried out (e.g. using the container inspection model of machine learning).

By means of these reference data, further sensor data detected by the sensor device, which were/are identified as defect-free (at least with regard to the specified defect) during the execution of the container inspection task, are preferably examined as to whether they (nevertheless) have a (minimum) similarity (e.g. specified by an operator) to these (defective) reference data and/or what degree of similarity they have to these reference data. As explained above, a similarity or degree of similarity of the respective sensor data to the reference data can be determined by using the distance metric to calculate a distance between a representation of the sensor data in the feature space and a representation of the reference data in the feature space (each as a feature vector).

If the calculated distance is below a predetermined value (which indicates the minimum similarity), the corresponding container part is considered sufficiently similar (with respect to the predetermined minimum similarity) to the reference data. In this case, for example, it may be a container part that already has slight degrees of the predetermined defect, but the container part (still) meets the (required, e.g. predetermined by the operator) quality requirements.

For example, a reusable glass bottle (as a container part) could already show so-called “scuffing” on the outer glass surface, wherein the scuffing—an abrasion of the glass surface—can occur, for example, when repeatedly guided through a reusable glass bottle filling plant. A minor degree of scuffing is visually noticeable but does not lead to any reduction in quality. Only when there is a high degree of scuffing, this glass container is removed from the container stream and sent to a recycling plant for example.

By carrying out the container inspection task, container parts (here glass bottles) are identified which, due to an identified very clear degree of “scuffing”, must be removed from the container stream and supplied to the recycling plant. It is now proposed to already obtain information about whether and how many non-rejected and/or non-rejectable container parts (in this case glass bottles) are present in the container part stream inspected by the sensor device, which already show scuffing to a predetermined degree, by carrying out the plant inspection task by additionally comparing the sensor data detected for each of (all) the inspected container parts with reference data. This may, for example, provide information about the plurality of container parts treated in the container treatment plant, such as their age and/or state.

Further preferably, based on such identified scuffing to a low degree, i.e. (generally) based on determined similarity variables preferably of a plurality of detected sensor data in each case with reference to the predetermined reference data, an adjustment is made to the container treatment plant, for example a control of a transport speed and/or a change of a guide device for guiding the containers to be transported.

As an example of a defect, so-called “scuffing” was presented above.

Additionally or alternatively, reference data are preferably predetermined which depict container parts with a predetermined defect which may arise when at least one or the at least one treatment step is carried out on the container part. In this way, it is advantageously possible to infer disturbances and/or adverse developments in the treatment process of the container treatment plant, for example in the blow molding process.

In this case, the cause of the predetermined defect may lie in the execution of the treatment step itself and/or in a state of the container treatment plant (or the container treatment device) such as an existing process temperature (such as a temperature in a heating device of the plastics material preforms).

In this case, such reference data or reference sensor data may originate from previous operations of the container treatment plant or from other (in particular identically constructed) container treatment plants.

Preferably (as described above) sensor data detected by the sensor device (as part of the execution of the plant inspection task) are evaluated with respect to the predetermined reference data by determining a similarity variable (as explained above) (preferably a distance using a distance metric).

Preferably, this plant inspection task is carried out with respect to a plurality of detected sensor data (relating to the container parts), for which the predetermined defect was not identified during the execution of the container inspection task, and/or whose associated container parts are not to be/were discharged from the container part stream on the basis of the inspection result of the container inspection task. This offers the advantage that precisely those sensor data whose quality is judged to be sufficient are analyzed in more detail. In this way, undesirable designs of the container parts that are already slightly apparent can be discovered.

Preferably, at least one plant inspection variable is determined on the basis of the plant inspection tasks carried out for a plurality of detected sensor data and/or the similarity variables determined in each case on the basis of the plurality of detected sensor data.

In this case, the determined plant inspection variable is characteristic of a deviation of at least one operating state of the container treatment plant and/or the/a treatment device from a normal state and/or a desired state.

Additionally or alternatively, the determined plant inspection variable is characteristic of an aging of at least one element of the container treatment plant and/or (the/)a treatment device and/or a fault condition present in the container treatment plant and/or (the/)a treatment device.

This offers the advantage that possible errors or aging (such as wear) or fault conditions in the container treatment plant can already be detected before they actually result in defects in the container parts (identified by the real-time evaluation device or using the container inspection model).

Thus, depending on the determined plant inspection variable, a suitable countermeasure and/or controls/regulations of at least one process in the container treatment plant can be carried out, which can counteract the observed development in the container treatment plant considered to be disadvantageous. Preferably, so-called “predictive maintenance” can be carried out depending on the plant inspection variable and/or depending on the determined similarity variables.

It is also conceivable that, depending on the determined plant inspection variable and/or depending on the determined similarity variables, a message is given to an operator that a maintenance interval should be shortened and/or maintenance should be carried out.

The similarity variables determined in each case for the plurality of detected sensor data are preferably evaluated with regard to their relative frequency occurring in the container part stream (when determining a plant inspection variable).

It is conceivable that the plant inspection variable is a statistical variable in which, for example, the similarity variables to sensor data with respect to more than 1,000 container parts, preferably more than 10,000, preferably at least 50,000 and particularly preferably at least 100,000 container parts are taken into account. This advantageously means that control/regulation of the container treatment plant is only undertaken on the basis of a statistically significant plant inspection variable.

Preferably, a number of labeled and/or classified sensor data (e.g. images) per application on the order of 1,000 to 100,000 (e.g. 10,000 labeled and/or classified images per application) is used to train the networks.

Preferably, the similarity variables determined with respect to predetermined reference data, such as the respective distances of the feature vectors of the detected sensor data from the feature vectors of the reference data, are examined for occurring patterns using (automatic or AI-based) pattern recognition methods. In this way, any (frequently) occurring (in particular unknown) peculiarities in the detected sensor data and thus in relation to the container parts can be detected. Preferably, peculiarities identified in this way are responded to for example by storing and evaluating the treatment data and/or status data of the treatment devices treating the respective container parts, which were available at the respective time of treatment. Preferably, the evaluation result is taken into account in the control and/or regulation of the container treatment plant.

It is also conceivable that the feature vectors determined for a plurality of detected sensor data are used to form a plurality of clusters using cluster analysis (e.g. k-means algorithm), to which the determined feature vectors are assigned and/or can be assigned. In this case, it is conceivable that the clusters obtained from this are evaluated with regard to known defects and/or features of the container parts to be inspected. For example, an obtained cluster can depict defect-free container parts. Other obtained clusters can represent grouped sensor data, each item of which depicts a container part with a (same) known defect.

Furthermore, clusters can be obtained in this way that group the detected sensor data of container parts that do not contain a known defect. Data characteristic of such a cluster, for example a centroid or a cluster center (and/or a variance) can be output to an operator and/or evaluated for as yet unknown defects and/or peculiarities/properties of the inspected container parts.

It is also conceivable that centroids or cluster centers obtained by cluster analysis (in particular in the feature space) are used as reference data.

In a further preferred method, at least one container inspection task is changed and/or adapted and/or supplemented depending on the inspection result of the plant inspection task. These values can be used for example to fine-tune threshold values for identifying defects in the container parts and/or to add newly detected defect types.

In a further preferred method, the similarity variable is characteristic of a similarity of the detected, in particular spatially resolved, sensor data for a predetermined and/or predeterminable plurality of, in particular spatially resolved, reference sensor data. A similarity variable can thus also be considered that indicates a similarity to several reference sensor data or is characteristic thereof.

In a further preferred method, the reference data, preferably the in particular spatially resolved reference sensor data, and/or the plurality of in particular spatially resolved reference sensor data, are predetermined by an operator of the container treatment plant, preferably using a human-machine interface of the container treatment plant. This offers the advantage that an operator can select, for example using an input device (e.g. designed as a touch display) (of the container treatment plant), detected sensor data suggested to the operator (e.g. by the inspection apparatus and/or the container treatment device), in particular by displaying them using a display device, as reference sensor data.

However, it is also conceivable that the operator can transmit the reference data, with respect to which the similarity variable is to be determined, via the human-machine interface of the container inspection apparatus and/or the container treatment plant. In this way, reference data can be defined in a user-friendly manner.

In a further preferred method, the container inspection task is a classification task which is selected from a group of classification tasks which comprise a (preferably binary) classification into defective and/or defect-free container parts and preferably containers (good/bad containers), a detection and/or classification of types of defects of the container part and preferably of the container, an identification and/or classification of different types of the container part and preferably of the container (for example, ten different bottle types), an identification and/or classification of a contour and/or color of the container part and preferably of the container, an identification and/or classification of a fault-free and/or faulty execution of at least one treatment step carried out on the inspected container part, in particular by the (first) treatment device, an identification of container part types and/or types of defects which occur comparatively rarely in the container part stream (rare means in particular less than 1/1000), a label check, a fill level check, a check of the foaming behavior of a liquid in a container, an identification of a hairline crack and/or mouth break of a container and/or break in a bottom region of the container, an identification of foreign particles arranged or located in or on the container part and/or container, and the like, as well as combinations thereof.

Preferably, the container inspection model of machine learning is based upon an (artificial) neural network. The neural network is preferably formed as a deep neural network (DNN) in which the parameterizable processing chain has a plurality of processing layers, and/or a so-called convolutional neural network (CNN) and/or a recurrent neural network (RNN) and/or other classes of DNN layers.

Preferably, the container inspection model of machine learning used by the real-time evaluation device is an already taught or (fully) trained container inspection model. In other words, the container inspection model to be trained or, more precisely, retrained with the training data set to be generated, is present in a state after completion of a training process. It is therefore conceivable that the container inspection model has already been trained with a general training data set, preferably independent of a specific or concrete container treatment plant.

Preferably, the data (to be processed), in particular the spatially resolved sensor data (or data derived therefrom), are supplied as input variables to the container inspection model or the (artificial) neural network. Preferably, the container inspection model or the artificial neural network maps the input variables to output variables depending on a parameterizable processing chain, wherein preferably a container inspection category being selected as the output variable, or preferably a plurality of container inspection categories being selected as the output variables.

Preferably, the plurality of (mutually different) container inspection categories relate to different types of defects of the container part. For example, mutually different container inspection categories may refer to different regions of the container part, which are selected, for example, from a group that comprises a bottom region, an outer wall region, a side wall region, a corrugation in the bottom region, a support ring region, a mouth region and the like, and combinations thereof.

The different container inspection categories can also arise depending on the container inspection task such as a check of a container part bottom, sealing surface, side wall, thread, closure, fill level, label, tamper evidence, suspended matter, residual liquid.

Additionally or alternatively, a container inspection category may also refer to (exactly or at least) one of (mutually) different defect types (such as crack, tear, fracture, etc.) and/or fault types, which may be selected from a group that comprises defects, fractures, cracks, different crack types, (glass) fragments, chipping, soiling, soiling types, material distributions in relation to a defect and the like, and combinations thereof.

Preferably, the container inspection model of machine learning or the artificial neural network is trained using predefined training data, wherein the training parameterizing the parameterizable processing chain.

In a preferred method, the training process of the container inspection model utilizes training data which comprise a plurality of spatially resolved sensor data (of containers) detected by the at least one sensor device. This offers the advantage that the training process is already specifically adapted to the container inspection apparatus to be set and, for example, specific conditions of the specific container inspection apparatus, such as optical properties of the sensor device or specific lighting conditions in the container inspection apparatus, can be taken into account directly.

Preferably, the spatially resolved sensor data (detected by the at least one sensor device) intended for use as training data are provided with (container) type and/or classification features. Preferably, the spatially resolved sensor data together with the (container) type and/or classification features assigned to them are stored as a training data set (in particular on a and/or the non-volatile storage device). A plurality of training data sets is preferably generated in this way. In this case, the classification features can be the container inspection categories (described above). For example, the spatially resolved sensor data assigned to a container can be classified with the types of defects and the like that occur in it.

The non-volatile memory device may be a memory device which is a (fixed) component of the at least one sensor device and/or the container inspection apparatus. It is conceivable that this memory device is a ring buffer in which the oldest sensor data are overwritten when the storage capacity is reached (and thus the stored sensor data are only available for a limited period of time).

The non-volatile memory device may also be a memory device of the container treatment plant, which is designed for example as a read-only memory.

“Non-volatile” can also mean that the selected images or sensor data and/or the sensor data stored on the non-volatile memory device are only retained for a certain period of time, i.e. they (can be)/are deleted after a configurable time or parameterization action (installer). “Non-volatile” can also mean that the images or sensor data do not need to be retained or stored beyond the machine being switched off.

“Non-volatile” also means that the image data to be “held” and/or the sensor data to be stored must, in the simplest case, be available for parameterization.

It is also conceivable that, in addition or alternatively, “non-volatile memory device” is understood to mean that the image data to be “held” and/or the sensor data to be stored are retained even when the memory device is not supplied with power.

Training the networks typically requires 10,000 or more marked and/or classified images/items of sensor data per application. This marking and/or classification can be carried out locally or centrally by image processing experts.

The working mode is preferably an ongoing (production) mode of the container inspection apparatus and/or an ongoing (production) mode of a container treatment plant, such as a container filling plant, which comprises the container inspection apparatus. In particular, the working mode may be a production mode. In particular, the working mode is not a test mode and/or maintenance mode and/or adjustment mode with a transport speed of the containers or container parts (as they pass through the container inspection apparatus) that is somewhat lower than a transport speed in a working mode.

The sensor device is preferably selected from a group that comprises an image recording device such as a camera (preferably black-and-white and/or color), a CMOS sensor (CMOS abbreviation for complementary metal-oxide-semiconductor), a CCD sensor, a 3D sensor, an X-ray-based image recording device, an optical element, a thermal imaging camera, a stereo camera, a LIDAR camera, an odor sensor and/or a (mass) spectrometer and the like, and combinations thereof.

In a preferred embodiment, the transport device transports the containers from a first treatment device to a further (or second) treatment device (and/or is in particular suitable and intended for this purpose).

Preferably, the first and/or the further treatment device is selected from a group which comprises an injection molding apparatus for producing an injection-molded part (such as a preform), a cleaning apparatus for cleaning the containers and/or container parts, a comminution device for comminution of the containers, a filling apparatus for filling the containers, a forming apparatus for forming a plastics material preform into a plastics material container, in particular a blow molding machine, a closure device for closing the containers, a labeling apparatus, a marking device, a sorting device, a packaging device (for wrapping and/or shrink-wrapping), a device for strapping a container part and/or container, a determination device for determining the composition of substances or mixtures of substances such as the atmosphere and/or air in or on a container part and preferably a container, for example a mass spectrometer and/or an odor sensor device, and the like, as well as combinations thereof.

Preferably, the container part stream is an (in particular continuous) stream of successive or consecutive containers (on the transport path). For example, the container part stream may be a container stream, namely a stream of successive or consecutive containers (on the transport path). In this case, the container part stream can be guided or transported in a single lane or in multiple lanes (using the transport device) regionally and preferably within the totality of the container inspection apparatus (as a mass stream). At least one sensor device is preferably assigned to each lane of the container part stream and detects each container part of the container part stream located on this lane.

In this case, the transport device can also be a mass transporter for the preferably multi-lane and/or unordered transport of a plurality of container parts and preferably of containers. In this case, the transport device can also be a buffer region for buffering, preferably in multiple lanes and/or in an unordered manner, a plurality of container parts and preferably containers.

The container parts and preferably the containers can be transported or guided standing or upright (by the transport device), preferably at least partially and preferably along the entire transport region.

Preferably, the transport device is suitable and intended for guiding or transporting the plurality of container parts and preferably containers, at least partially, preferably along the entire transport region, of container parts and preferably containers that are under dynamic pressure.

Preferably, the transport device is suitable and intended for transporting and/or guiding (at least within the transport region) at least 1 container part (and preferably at least one container) per hour, preferably at least 5,000 container parts (and preferably containers) (in particular to be inspected) per hour, preferably at least 20,000 container parts (and preferably containers) (in particular to be inspected) per hour, preferably at least 100,000 container parts (and preferably containers) (in particular to be inspected), preferably at least 140,000 container parts (and preferably containers) (in particular to be inspected), and particularly preferably at least 180,000 container parts (and preferably containers) (in particular to be inspected), and carries this out within the working mode of the treatment device and/or container treatment plant. Preferably, the transport device is suitable and intended for transporting and/or guiding (at least within the transport region) a maximum of 180,000 (particularly preferably a maximum of 200,000) container parts (and preferably containers), in particular to be inspected, per hour and carries this out within the working mode of the treatment device and/or the container treatment plant and/or the container inspection apparatus.

Preferably, the transport device is suitable and intended for transporting and/or guiding (at least within the single-lane transport region) at least 100,000 container parts (and preferably containers) per hour and/or up to 180,000 (particularly preferably at most 200,000) container parts (and preferably containers) per hour in a single-lane transport region, and carries this out within the working mode of the treatment device and/or the container treatment plant and/or the container inspection apparatus.

The containers may be preforms from which fully formed containers are produced by a forming process and/or which have so far only been produced by a primary forming step. The containers can also be already fully formed containers which have reached their final shape, for example, through a forming process of a preform (such as an injection-molded part or a molded part).

The containers may be containers that are empty, still to be filled and/or to be recycled and/or to be refilled. The containers can also be filled containers. Additionally or alternatively, the containers may be containers that are sealed and/or sealable with (in particular precisely) one container closure.

The containers may be disposable containers or reusable containers.

The containers are preferably (preferably leak-proof) in particular sealable containers for holding liquids and/or flowable substances, such as pasty and/or cream-like and/or gel-like substances such as those from the food sector, from the cosmetics industry or from the pharmaceutical sector.

It is also conceivable that the containers are containers for holding liquids and/or bodies such as containers for contact lenses.

The external memory device is a cloud-based (preferably non-volatile) memory device and/or an external server (including memory device), wherein the memory device being accessed in particular via the Internet (and/or via a public and/or private network, in particular at least partially wired and/or wireless). An external server is understood to be in particular an external server, in particular a backend server, in relation to a container inspection apparatus and/or real-time evaluation device.

The external server is, for example, a backend, in particular of a container treatment plant manufacturer or a service provider, which is configured to manage spatially resolved sensor data (in particular of a plurality of sensor devices and/or a plurality of container inspection apparatuses) and/or to carry out machine learning methods with regard to (training) container inspection tasks to be carried out and/or to set up and/or adapt real-time evaluation devices. The functions of the backend or the external server can be carried out in (external) server farms. The (external) server can be a distributed system.

The present invention is further directed to a control apparatus for a container treatment plant for treating a plurality of container parts for containers and preferably for plastics material containers and/or bottles.

In this case, the container treatment plant has a transport device for transporting the plurality of container parts as a container part stream along a predetermined transport path from at least one treatment device of the container treatment plant to at least one further treatment device of the container treatment plant.

In this case, for carrying out a container inspection task, the container treatment plant has at least one sensor device which is suitable and intended for detecting, preferably optically, in particular spatially resolved sensor data and preferably camera images with respect to the container parts.

In this case, the container treatment plant has a real-time evaluation device which is suitable and intended for evaluating the in particular spatially resolved sensor data in real time using a machine learning container inspection model which comprises a set of parameters which are set to values that were learned as a result of a machine learning method.

According to the invention, the control apparatus is suitable and intended for evaluating the detected, in particular spatially resolved, sensor data in relation to predetermined and/or predeterminable reference data by determining a similarity variable which is characteristic of a similarity of the sensor data to the reference data.

In this case, the similarity variable is preferably determined based on a predetermined set of container part features, particularly preferably based on the machine learning method.

According to the invention, the control apparatus is suitable and intended for providing the similarity variable or a variable derived therefrom for controlling and/or regulating the container treatment plant, and/or for controlling and/or regulating the container treatment plant or one of the treatment devices of the container treatment plant depending on the similarity variable or a variable derived therefrom.

It is therefore also proposed within the scope of the invention that the sensor data are not only evaluated with the container inspection model, but rather that an additional evaluation of the sensor data is carried out, which is based on a determination of the similarity of the detected sensor data to predetermined or predeterminable reference data. In this way, an AI-based evaluation model perceivable per se as a “black box” can be supplemented by a similarity analysis of the imaged container parts.

Preferably, the control apparatus is configured, suitable and/or intended for carrying out the method described above as well as all method steps already described above in connection with the method, individually or in combination with one another, in particular with regard to the determination of the similarity variable(s) and/or a plant inspection variable. Conversely, the method may be provided with all of the features described within the context of the control apparatus, individually or in combination with one another.

The present invention is further directed to a container treatment plant for treating a plurality of container parts for containers. This comprises a transport device for transporting the plurality of container parts as a container part stream along a predetermined transport path from and/or to at least one treatment device of the container treatment plant, preferably from the at least one treatment device to at least one further treatment device of the container treatment plant.

In this case, for carrying out a container inspection task, the container treatment plant has at least one sensor device which is suitable and intended for detecting, preferably optically, in particular spatially resolved sensor data and preferably camera images with respect to the container parts.

In this case, the container treatment plant further comprises a real-time evaluation device which is suitable and intended for evaluating the in particular spatially resolved sensor data in real time using a container inspection model of machine learning. In this case, the machine learning container inspection model includes a set of parameters that are set to values that were learned as a result of a machine learning method.

According to the invention, the container treatment plant has a control apparatus as described above.

The container treatment plant is preferably configured, suitable and/or intended for carrying out the method described above for operating a container treatment plant, as well as all the method steps already described above in connection with the method, individually or in combination with one another. Furthermore, the container treatment plant and/or the treatment device and/or the at least one further treatment device and/or the transport device can have or be equipped with at least one feature described above, individually or in combination with further features.

The present invention is further directed to a computer program or computer program product comprising program means, in particular a program code, which represents or encodes at least some and preferably all of the method steps of the method according to the invention and preferably one of the described preferred embodiments and is designed to be executed by a processor device.

The present invention is further directed to a data memory on which at least one embodiment of the computer program according to the invention or a preferred embodiment of the computer program is stored.

The present invention has been described with reference to a container or container parts for containers. The present invention is also transferable to injection-molded parts (moldings) or generally to articles to be treated in a treatment plant (such as contact lenses to be manufactured and/or packaged), the treatment progress and/or the properties and/or (defect/quality) states of which are monitored by at least one sensor device (for detecting in particular spatially resolved sensor data with respect to each individual article to be inspected). The applicant reserves the right to also claim related items.

The present invention is further directed to a method for operating an article treatment plant for treating a plurality of injection-molded parts and/or articles, wherein a transport device transporting the plurality of injection-molded parts and/or articles as a parts stream along a predetermined transport path from at least one treatment device of the article treatment plant to at least one further treatment device of the article treatment plant, wherein to carry out an article inspection task, at least one sensor device detects, in particular spatially resolved, sensor data and preferably camera images with respect to the injection-molded parts and/or articles, preferably optically, and a real-time evaluation device evaluating the, in particular spatially resolved, sensor data in real time using a machine learning article inspection model which comprises a set of parameters which are set to values which were learned as a result of a machine learning method.

According to the invention, a set of article features based on a and preferably the machine learning method is predetermined, and the detected, in particular spatially resolved, sensor data are evaluated with respect to a plant inspection task different from the article inspection task based on the predetermined set of article features, wherein at least one plant inspection variable being determined depending on the inspection result of the carried out plant inspection task, which is provided for controlling and/or regulating the article treatment plant.

The present invention is further directed to a control apparatus for an article treatment plant for treating a plurality of injection-molded parts and/or articles, wherein the article treatment plant having a transport device for transporting the plurality of injection-molded parts and/or articles as a parts stream along a predetermined transport path from at least one treatment device of the article treatment plant to at least one further treatment device of the article treatment plant, wherein the article treatment plant having at least one sensor device for carrying out an article inspection task, which is suitable and intended for capturing, preferably optically, in particular spatially resolved sensor data and preferably camera images with regard to the injection-molded parts and/or articles, and wherein the article treatment plant having a real-time evaluation device which is suitable and intended for evaluating the in particular spatially resolved sensor data in real time using a machine learning article inspection model which comprises a set of parameters which are set to values that were learned as a result of a machine learning method.

According to the invention, the control apparatus is suitable and intended for evaluating the detected, in particular spatially resolved, sensor data in relation to predetermined and/or predeterminable reference data by determining a similarity variable which is characteristic of a similarity of the sensor data to the reference data, wherein the similarity variable preferably being determined based on a predetermined set of article features, particularly preferably based on the machine learning method, wherein the control apparatus being suitable and intended for providing the similarity variable or a variable derived therefrom for controlling and/or regulating the article treatment plant.

The further features described above in the context of the container parts are correspondingly analogously applicable to the injection-molded parts and/or articles.

### BRIEF DESCRIPTION OF THE DRAWINGS

Further advantages and embodiments emerge from the accompanying drawings in which:

FIG. 1 shows a schematic representation of a container treatment plant according to the invention according to a preferred embodiment; and

FIG. 2 shows camera images to illustrate the determined similarity variables.

### DETAILED DESCRIPTION OF THE INVENTION

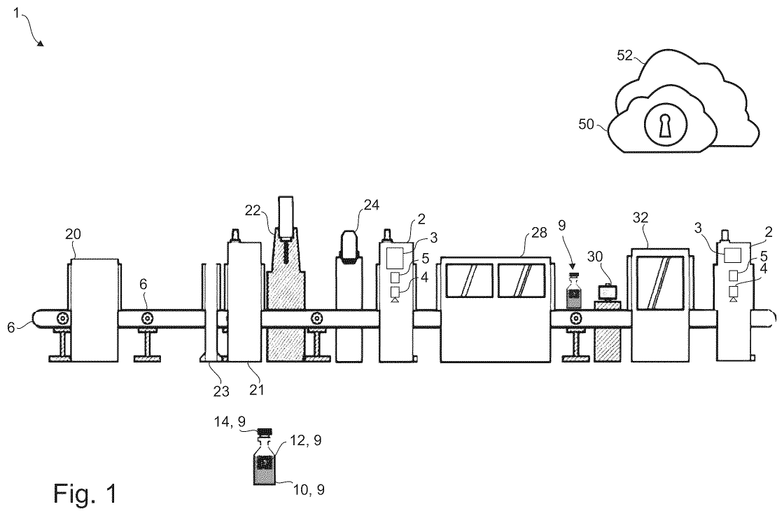

FIG. 1 shows a schematic view of a container treatment plant 1 according to the invention for treating container parts 10, here containers 10 designed as bottles, in accordance with a first embodiment.

The reference sign 12 denotes an equipment arranged on the container part 10, here a container. In the embodiment shown in FIG. 1, an identification means is shown, by way of example, as equipment, which is arranged on the bottle 10. This is, for example, a (printed) QR code. The reference sign 14 designates a container closure as further equipment of the container 10.

In the embodiment shown in FIG. 1, a plastics material preform is provided and supplied from the transport device 6 to a heating device 20, heated therein and subsequently expanded in a blow molding apparatus as a further treatment device, the arrangement of which within the container treatment plant 1 is indicated by the reference sign 23, to form a (plastics) bottle 10. This bottle 10 can for example be provided with an identification means 12 by the individualization device, for example a printing device, which results in a bottle that has an identification means 12.

The container part 9 can be transported in the container treatment plant 1 by at least one transport device 6 from one treatment device to the next, as well as within the treatment device(s). Shown here as treatment devices (in a sequence downstream of the direction of transport of the bottle) are an inspection apparatus 21, a filling apparatus 22 for filling the bottle 10 with a product, a closing apparatus 24, a drying apparatus 28, a labeling apparatus 30, as well as a packaging device 32 for packaging the bottle 10.

The reference signs 2 each indicate a further container inspection apparatus (for example at the end of the line and arranged between the closure device 24 and the drying device 28) which checks, for example, a fill level in the bottle and/or a proper arrangement of the closure on the bottle 10 and/or a retaining ring and/or proper labeling and/or packaging of the bottle 10 or further production data.

The reference sign 4 denotes in each case a sensor device, here a camera, by which—individually for each container part 9 (to be inspected)—sensor data are collected, or detected or recorded in relation to the respective container part 9.

The reference sign 3 denotes a real-time evaluation device by which the sensor data detected by the sensor device 4 of the respective container inspection apparatus 2 are evaluated in order to carry out a (predetermined and/or specified) container inspection task.

In a preferred proposed method, a set of extracted features is used to evaluate the detected sensor data. The employed set of extracted features is the result of a (trained) feature extraction by a neural network that was pre-trained with (extensive) (training) data on similar (inspection) tasks of image classification. However, in the final step of evaluating the extracted features, a conventional classification method is then applied.

The reference sign 50 denotes an internal server or an internal memory device, and the reference sign 52 denotes an external server or an external, in particular cloud-based, memory device. For example, AI-based feature extraction can be performed on the external server 52. The obtained set of extracted container part features can preferably be stored on the external and/or internal memory device 50/52.

The reference sign 5 denotes a memory device which here is a (fixed) component of the container inspection apparatus 2. Sensor data detected by the sensor device 4 can be stored on this memory device 2.

Preferably, for example, an image (as reference data) of a specific defect or feature of the container part can be used as a reference. Using a preferably AI-based similarity metric, the similarity of the images detected by the camera to the reference image can be determined. This also makes it possible to find camera images that show containers with the specific defect or feature being sought with only a slight degree of severity, but whose corresponding containers are not recognized and/or rejected due to the low degree of severity. If, for example, several containers with even a slight degree of this defect are detected (increasingly frequently), this may for example indicate a continuously increasing deviation of a process parameter (e.g. temperature of a cleaning fluid and/or temperature in a heating device for heating the plastics material preforms).

For this purpose, the container inspection apparatus 2 or a control apparatus can preferably determine a similarity variable which is characteristic of a similarity of the detected images or sensor data to predetermined and/or predeterminable reference data (such as a reference image).

Depending on the similarity variable determined in each case, a plant inspection variable can be determined which is characteristic of an (undesirable) actual state of the container treatment plant and/or a container treatment device (e.g. temperature state).

Depending on this plant inspection variable, for example the state of the container treatment plant and/or the container treatment device can then be controlled/regulated in order to achieve a (desired) target state.

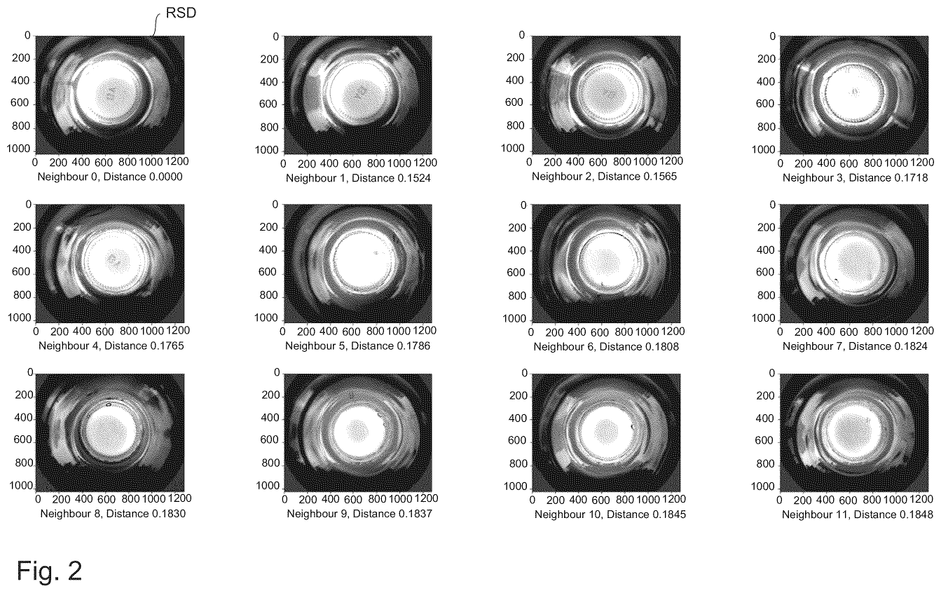

FIG. 2 shows twelve camera images to illustrate a determined similarity variable.

In particular, these (and further camera images not shown) were used to assess similarity. FIG. 2 shows a result of the camera images sorted according to their similarity (with descending similarity).

These camera images are taken during a bottom inspection of a container by a camera that inspects the bottom of the container through the mouth of the container. In this case, the bottom is illuminated by a lighting device in a transmitted light process.

The first image, top left in the figure plane of FIG. 2, which is marked with the reference sign RSD, is used as the reference image. This therefore has a distance of 0 to itself, determined using a distance metric (e.g. a Euclidean one).

The further camera images shown in FIG. 2 are sorted according to the respective distance to the reference image determined with respect to the distance metric (from left to right, then from top to bottom), and thus show an increasing distance, i.e. a decreasing similarity.

The last camera image, located in the lower right of the figure plane, has the greatest distance compared to the other camera images shown in FIG. 2 with a distance of 0.1848 and is thus the eleventh neighbor of the reference image.

These camera images can be used to illustrate the high performance of the proposed method. The reference image RSD shows a container bottom with an embossing “BA”. The camera images that are assessed by the proposed method as being most similar thereto, namely the 1st neighbor (“Neighbor 1”) and the 2nd neighbor (“Neighbor 2”), also show (with decreasing clarity) such an embossing “BA”. The 3rd neighbor (“Neighbor 3”) shows a drop in the middle, which also has a similar round shape to the inner contour of the “B”.

FIG. 2 shows that by the proposed method, carrying out an evaluation of a similarity using a distance metric in a feature space (wherein the feature space is spanned by features extracted in an AI-based training method), in which the images are each represented as feature vectors, can allow all container bottoms with the embossing “BA” to be sortable among the nearest four neighbors.

This method makes it possible to determine images, from the detected images (of a container stream), that are similar to a predetermined reference image. From this result of the determination, it can then be concluded whether the container treatment plant is carrying out smooth operation or—on the other hand—whether intervention in the control and/or regulation is necessary.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different figures.

### LIST OF REFERENCE SIGNS

1 container treatment plant
2, 21 container inspection apparatus
3 real-time evaluation device
4 sensor device
6 transport device
10 container
9 container part
12 equipment, direct printing element
14 equipment, container closure
20 treatment device, here heating device
23 treatment device, here pressure device
22 treatment device, here filling device
24 treatment device, here closing device
28 treatment device, here drying device
30 treatment device, here labeling device
32 treatment device, here packaging device
50 internal server, memory device
52 external server memory device

1. A method for operating a container treatment plant for treating a plurality of container parts for containers, wherein a transport device transporting the plurality of container parts as a container part stream along a predetermined transport path from at least one treatment device of the container treatment plant to at least one further treatment device of the container treatment plant, wherein in order to carry out a container inspection task, at least one sensor device detects sensor data relating to the container parts, and a real-time evaluation device evaluates the sensor data in real time using a machine learning container inspection model which comprises a set of parameters that are set to values which were learned as a result of a machine learning process,
wherein
a set of container part features based on a machine learning method is predetermined, and the detected sensor data are evaluated with respect to a plant inspection task different from the container inspection task based on the predetermined set of container part features, wherein at least one plant inspection variable being determined depending on the inspection result of the carried out plant inspection task, which is provided for controlling and/or regulating the container treatment plant.

2. A method for operating a container treatment plant for treating a plurality of container parts for containers, wherein a transport device transporting the plurality of container parts as a container part stream along a predetermined transport path from at least one treatment device of the container treatment plant to at least one further treatment device of the container treatment plant, wherein in order to carry out a container inspection task, at least one sensor device detects sensor data relating to the container parts and a real-time evaluation device evaluates the sensor data in real time using a machine learning container inspection model which comprises a set of parameters that are set to values which were learned as a result of a machine learning process,
wherein
the detected sensor data are evaluated in relation to predetermined and/or predeterminable reference data by determining a similarity variable which is characteristic of a similarity of the sensor data to the reference data, wherein the similarity variable or a variable derived therefrom being provided for the control and/or regulation of the container treatment plant.

3. The method according to claim 1, wherein the set of container part features is a set of extracted container part features obtained as part of the machine learning method.

4. The method according to claim 3, wherein the learning method within the context of which the set of container part features is extracted is a supervised learning method, preferably a K-nearest neighbor algorithm.

5. The method according to claim 1, wherein on the basis of the evaluation of the sensor data detected with respect to a container part, based on the set of container part features, a movement of the container part through the container treatment plant is tracked at least partially.

6. The method according to claim 5, wherein, the tracking of the container part is carried out without a treatment step provided for individualization having been and/or being carried out on the container part.

7. The method according to claim 1, wherein, based on the set of container part features, the sensor data detected with respect to a container part are evaluated in such a way that at least one identification variable characteristic of the container part is determined.

8. The method according to claim 1, wherein, on the basis of the evaluation of the sensor data recorded with respect to a container part, a check is made using the set of container part features as to whether an individual container part (9) has repeatedly reached the sensor device.

9. The method according to claim 8, wherein, in order to check a repeated reaching of the sensor device detecting the individual container part, an identification variable characteristic of the container part is determined based on the set of container part features and, on the basis of the determined identification variable, a similarity to sensor data subsequently detected by the sensor device is determined.

10. The method according to claim 9, wherein if it is determined that the sensor device is repeatedly reached by a container part, a renewed transport of the container part to this sensor device is prevented.

11. The method according to claim 1, wherein reference data are predetermined and/or can be predetermined, and the control and/or regulation is based on a determined similarity variable which is characteristic of a similarity between the reference data and sensor data detected with respect to at least one container part.

12. The method according to claim 10, wherein at least one treatment step and/or at least one operating state of the container treatment plant is changed and/or adapted depending on the inspection result of the plant inspection task.

13. The method according to claim 12, wherein, depending on the inspection result of the plant inspection task, at least one container inspection task is changed and/or adapted and/or supplemented.

14. A control device for a container treatment plant for treating a plurality of container parts for containers, wherein the container treatment plant having a transport device for transporting the plurality of container parts as a container part stream along a predetermined transport path from at least one treatment device of the container treatment plant to at least one further treatment device of the container treatment plant, wherein the container treatment plant having at least one sensor device for carrying out a container inspection task, which sensor device is configured for detecting sensor data relating to the container parts, preferably optically, and wherein the container treatment plant having a real-time evaluation device which is configured for evaluating the sensor data in real time using a machine learning container inspection model which comprises a set of parameters which are set to values that were learned as a result of a machine learning method,
wherein
the control device is configured for evaluating the detected sensor data in relation to predetermined and/or predeterminable reference data by determining a similarity variable which is characteristic of a similarity of the sensor data to the reference data, wherein the control device being configured for providing the similarity variable or a variable derived therefrom for controlling and/or regulating the container treatment plant.

15. A container treatment plant for treating a plurality of container parts for containers, comprising a transport device for transporting the plurality of container parts as a container part stream along a predetermined transport path from at least one treatment device of the container treatment plant to at least one further treatment device of the container treatment plant, wherein the container treatment plant having at least one sensor device for carrying out a container inspection task, which sensor device is configured for detecting sensor data relating to the container parts, and wherein the container treatment plant having a real-time evaluation device which is configured for evaluating the sensor data in real time using a machine learning container inspection model which comprises a set of parameters which are set to values which were learned as a result of a machine learning method, wherein the container treatment plant has a control device according to claim 14.

16. The method according to claim 2, wherein the set of container part features is a set of extracted container part features obtained as part of the machine learning method.

17. The method according to claim 16, wherein the learning method within the context of which the set of container part features is extracted is a supervised learning method, preferably a K-nearest neighbor algorithm.
